(19) United States
(12) Patent Application Publication
(10) Pub. No.: US 2004/0256457 A1
(43) Pub. Date: Dec. 23, 2004

(54) Method and configuration for the output of product information on an output device

(76) Inventor: Bernhard Reissner, Rimbach (DE)

Correspondence Address: NOTARO AND MICHALOS, 100 DUTCH HILL ROAD, SUITE 110, ORANGEBURG, NY, 10962-2100, US

(21) Appl. No.: 10/823,914

(22) Filed: Apr. 14, 2004

(30) Foreign Application Priority Data
Apr. 25, 2003 (EP) 03 009 408.0

(51) Int. Cl. G06K 15/00

(52) U.S. Cl. 235/383

(57) ABSTRACT

The invention relates to a method and a configuration for the output of product information on an output device, in which, first, through suitable selection means the

selection of a product

selection of an output type

selection of the output device, and

optionally the selection of an output number takes place,

subsequently these selected data are transmitted to the data processing means through a first operative connection between the selection means and a data processing means and in the data processing means, based on the selected data and information about the selected product, which are stored in the data processing means, output information is created, which is called up by the output device via a second operative connection between the output device and the data processing means, is optionally further processed and output. The problem of continuously changing product information, which is to be displayed as uniformly as possible on all output devices of a commercial chain, is solved thereby that the output device(s) is(are) operated independently of the data processing means.

The present invention relates to a method for the output of product information on an output device, in which, first, through suitable selection means,

selection of a product

selection of a an output type

selection of the output device, and

optionally the selection of an output number

takes place, subsequently these selected data are transmitted to a data processing means through a first operative connection between the selection means and the data processing means, and, based on the selected data and information about the selected product, which are stored in the data processing means, in the data processing means output information is created, which is called up by the output device via a second operative connection between the output device and the data processing means, optionally is further processed and output.

The invention further relates to a system for carrying out this method, comprising:

at least one selection means for selecting a product, an output type of an output device and optionally an output number,

a data processing means connected through at least a first operative connection with the selection means, and

at least one output device connected through at least a second operative connection with the data processing means,

and the data processing means comprises a data base with information about the selected product, from which it creates output information and the output device optionally further processes the output information and subsequently outputs it.

Until now such methods and systems have offered the user the capability of the output of product information on site, in that at a data processing means a product and an output type, i.e. a specific layout, for example, poster/labels/presentations, is created and subsequently output on an output device connected to the data processing means.

The previous solutions for creating product information have some significant disadvantages. It is, for example, required that the different information on which the product information is based, such as for example the price, the product description, the logo of the product or specific forms and content specification, changes and must continuously be available in updated form to the data processing means. This is more difficult if the commercial enterprise, which wishes to create product information, wants to ensure a uniform form and a uniform price structure even if they are distributed to widely dispersed locations.

The preparation of product information, moreover, is to be possible without trained personnel needing to be present on location in each business branch to create the product information and to present it at the correct sites.

The present invention therefore addresses the task of specifying a method and a configuration in which the above described problems are eliminated.

The task is solved in the method according to the species thereby that the output device(s) is(are) operated independently of the data processing means.

The task of the present invention is, in addition, solved through the system according to the species thereby that the output device(s) is(are) operated independently of the data processing means.

A further advantageous implementation of the invention is provided thereby that the output information is made available on the data processing means to be called up by the output device and is called up by the output device via the second operative connection. This makes possible the individual control of the particular output devices, which can check on the data processing means, for example at time intervals of 1/10 seconds, one second, five seconds, ten seconds or more, whether or not updated output information is available for the particular output device. It is understood that the time intervals can also be adapted to the business hours of the store.

A further advantageous embodiment of the configuration provides that the output information is made available with an identification for the purpose of being called up, and the output devices are developed such that they call up the output information, made available by the data processing means, with the identification associated with this output device. Thereby that the output devices process and output automatically, i.e. with their own logic, the transmitted output information, the data processing means can be disposed at a central location, for example in the central offices of the company or in a computing center.

A further advantageous embodiment of the present invention provides that the output device is automatically determined by the data processing means based on the selection of the output type. This is possible in advantageous implementation if the output device is a device (for example a flat screen monitor) predefined in the data processing means of a specific size.

A further advantageous embodiment provides that the selection means is a mobile terminal device and the first operative connection is a radio connection. The selection of the products in the business branches can in this way take place directly on the shelf or at any desired site.

A further advantageous embodiment provides that the selection of the product is carried out via a bar code or RFID reader integrated in the selection means. This reduces the error proneness considerably.

A further embodiment of the invention provides that the product identification is carried out at the selection means as well as also in the data processing means via a product code number (EAN) or RFID number. Uniform processing and greater security in the communication between selection means and data processing means are hereby attained.

A further advantageous embodiment of the invention provides that the selection means is a terminal device with Internet browser and the available data are stored on the data processing means as Internet pages, which can be called up and which can be selected with the Internet browser. Due to the user interface, which is uniform in the Internet browser, simple operation and input or selection of the data by the user is made possible.

A further advantageous embodiment of the invention provides that the selection means is a merchandise management system, in which, due to a change of the price or another change of the product description, data are transmitted to the data processing means and here new output information is automatically generated for the corresponding output device.

In this way the reliable matching of the product information presented to the customer on site with the calculated price or to the product description is attained.

A yet further embodiment of the invention provides that in the data processing means access by the output devices to the output information is recorded. By keeping a record of the product information shown to the customer, a specific evaluation can be carried out of the various factors affecting the purchase, such as pricing, layout, manner of presentation and further information together with the information of the check-out systems. In this way sales promotion of specific items can be accomplished.

A further advantageous embodiment of the invention provides that the second operative connection is an Internet connection. This allows the advantageous utilization of an already existing worldwide network.

An additional further advantageous embodiment of the invention provides that the output information made available on the data processing means is made available as raw data. This offers the advantage that the data transmission across the second operative connection takes place faster and the processing of the data in the output device is significantly faster.

Further embodiments and advantages of the invention are found in the Figures of the drawing, the description of the Figures and the claims.

The Figures depict specifically:

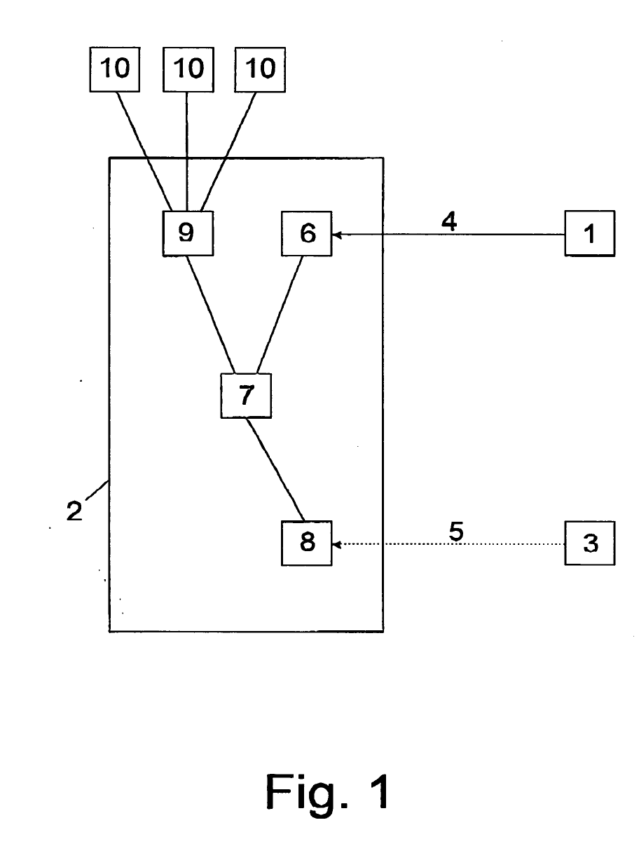

FIG. 1 a diagram of the system with a selection means and an output device,

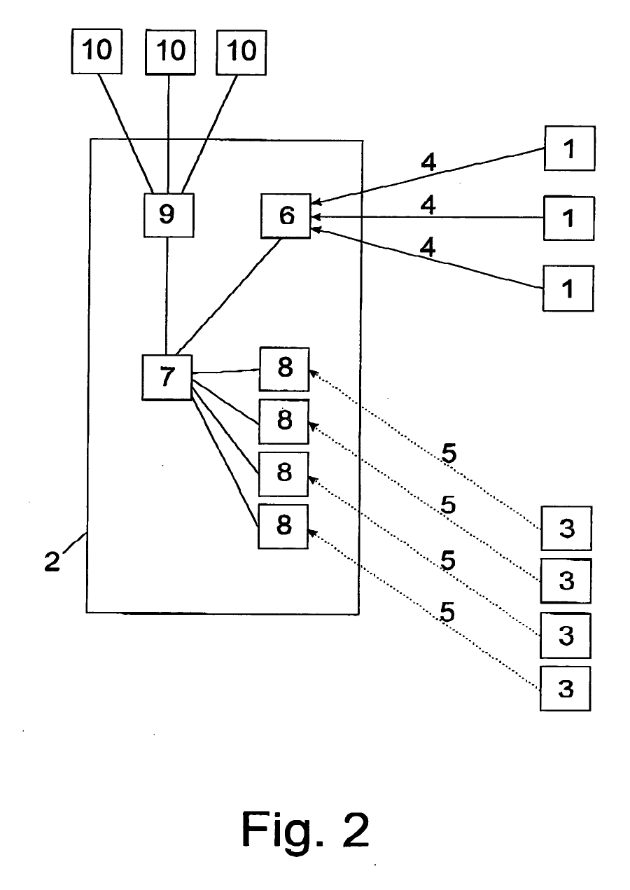

FIG. 2 a diagram of the system with several selection means and several output devices.

In the upper right of FIG. 1 a selection means 1 is shown, with which a selection of the product information to be created takes place by the user or by automated processes, such as for example the change of a price or of a product description in the merchandise management system.

As the selection means 1 can serve, for example, a local computer, also referred to as client. On it, for example, the available products can be ready for selection. These can advantageously be selected on the computer by means of bar code or via the EAN product number or an RFID number. In this way errors are avoided and the fast processing or selection of the product is possible. Moreover, according to the invention it is required that the desired output type or the desired output device be chosen on the computer. The selection of the output device can already lead to the necessary output type if, for example, as the output device a flat screen monitor, preferably an LCD display, is utilized.

If, for example, as the output device a printer or plotter is used, the number of desired printouts must additionally be selected on the computer or the selection means.

The system or the method can be implemented to be even more user-friendly if as the selection means a mobile computer, for example a laptop or a handheld computer is employed, which must have the same functions as said computer. This mobile terminal device can, moreover, also comprise a module which facilitates the selection of the output device, thereby that on the output device an identification is disposed, which can be read or scanned by the laptop or the handheld computer. This identification can advantageously be a bar code or an RFID or a numerical code.

The selection means 1 is connected across a first operative connection 4 with a selection data receiving unit 6, which is disposed in the data processing means 2. The first operative connection 4 can be connected through network cabling as well as also through a radio link or, depending on the distance, by mobile radio (for example a UMTS connection) to the selection data receiving unit 6. The selection data receiving unit 6 stores the received selection data in the data processing means 2. The selection data receiving unit 6 can advantageously also be comprised of an Internet page, which offers the user the available selection options on the selection means 1. In this way a uniform appearance of the selection options is ensured and the redundant storage of the selection data and the available selection options on the selection means 1 is not required.

The data processing means 2 is, for example, a company electronic data processing center or one or more computers, also referred to as server or server pool. The computer includes further a data base 9, which contains all remaining raw data necessary for creating the product information. These raw data are for example layout patterns, forms, graphics, item descriptions, descriptions of the content materials, etc., which are supplied from the outside by different data base information sources 10 with said information. These data base information sources 10 can be, for example, a merchandise management system, a marketing department, a software company or a further service provider (for example a picture agency or a design office).

The data from the selection data receiving unit and the data base are automatically combined by the software 7 into product information as soon as the corresponding command has been received. This command can be triggered either by confirmation on the selection means or by other changes of information in the data base 9.

The software 7 transmits the product information to a provision unit 8, which can also be disposed in the data processing means 2. The product information is provided in the provision unit 8 in a form, which can differ depending on the output device 3. The product information can advantageously also be made available as raw data, for example ASCII or ANSI or unicode, such that the transmission over the second operative connection 5, which most often represents the bottleneck, can take place several times faster. The second operative connection 5 can be comprised of the same elements as the first operative connection 4.

The completed product information can already be present in the provision unit 8. This is the case if the output device 3 is a simple printer without software or processor for the conversion of the raw information. However, it can also be an intelligent printer or a display with its own intelligence such that the provided raw data are not processed until they reach the output device 3. It is understood, that the transmission can also take place in compressed form.

With this system or method it is furthermore possible in an especially advantageous manner to output moving pictures or sequences as components of the output information or product information on the output device 3.

In contrast to FIG. 1, in FIG. 2 any desired number of selection means 1 is depicted, which are connected across a first operative connection 4 with the selection data receiving unit 6 of the data processing means 2. The selection means 1 transmits the selection data to the selection data receiving unit 6, which, for example via the particular product identification or via the identification of the output device 3, in the same manner as described in FIG. 1, are further processed and transmitted by the software 7 to the corresponding provision unit 8. Any desired large number of output devices 3 is each connected via second operative connections 5 with the provision units 8, where they call up via an identification the product information provided for the particular output device 3.

As already described, the provision unit 6, similar to the selection data receiving unit 6, can be an integrated unit to which all selection devices 3 have access, and the decision of which information is intended for the particular output device 3, takes place through the corresponding identification of the output device 3.

A further function, which can either be acquired in the software 7 or in the provision unit 8, is the creation of a log file, which acquires information about the called-up product information and makes it available for evaluation by the software 7.

### List of Reference Numbers

1 Selection means

2 Data processing means

3 Output device(s)

4 First operative connection

5 Second operative connection

6 Selection data receiving unit

7 Software

8 Provision unit

9 Data base

10 Data base information source

1. Method for the output of product information on an output device, in which, first, through suitable selection means the selection of a product, selection of an output type, selection of the output device, and optionally the selection of a number of outputs takes place, subsequently these selected data are transmitted through a first operative connection between the selection means and a data processing means to the data processing means, and in the data processing means, based on the selected data and information about the selected product, which are stored in the data processing means, output information is created, which by the output device via a second operative connection between the output device and the data processing means is called up, optionally further processed and output, characterized in that the output device(s) is(are) operated independently of the data processing means.

2. Method as claimed in claim 1, characterized in that the output information is made available for being called up by the output device on the data processing means and is called up by the output device via the second operative connection.

3. Method as claimed in claim 1, characterized in that the output device is automatically determined by the data processing means on the basis of the selection of output type.

4. Method as claimed in claim 1, characterized in that the selection of the product is carried out via a bar code or RFID reader integrated in the selection means.

5. Method as claimed in claim 1, characterized in that the product identification is carried out at the selection means as well as also in the data processing means via a product identification number (EAN or RFID number).

6. Method as claimed in claim 1, characterized in that in the data processing means each access of the output devices to the output information is recorded in a protocol.

7. Method as claimed in claim 1, characterized in that the output information made available on the data processing means is made available as raw data.

8. System for carrying out the method as claimed in claim 1, comprising:
at least one selection means (1) for the selection of a product, an output type of an output device (3) and, optionally, of an output number,
a data processing means (2), which is connected across at least one first operative connection (4) with the selection means (1), and
at least one output device (3), which is connected across at least one second operative connection (5) with the data processing means (2), with the data processing means (2) being comprised of a data base (9) with information about the selected product, from which output information is created and the output device(s) (3) optionally process(es) further the output information and subsequently output(s) it, characterized in that the output device(s) (3) is(are) operated independently of the data processing means (2).

9. System as claimed in claim 8, characterized in that the output information is made available on the data processing means (2) for being called up by the output device(s) (3) and is called up across the second operative connection (5) by the output device (3).

10. System as claimed in claim 8, characterized in that the output information, provided with an identification, is made available for being called up, and the output device(s) (3) is(are) developed such that it(they) call up the output information made available by the data processing means (2) with the identification assigned to this output device (3).

11. System as claimed in claim 8, characterized in that the selection means (1) is a mobile terminal device and the first operative connection (4) is a radio connection.

12. System as claimed in claim 8, characterized in that the selection means (1) comprises a bar code or RFID reader for the selection of the product.

13. System as claimed in claim 8, characterized in that the product identification takes place at the selection means (1) as well as also in the data processing means (2) via a product identification number (EAN or RFID number).

14. System as claimed in claim 8, characterized in that the selection means (1) is a terminal device with Internet browser and the data available for selection are stored on the data processing means (2) as Internet pages, which can be called up for the selection with the Internet browser.

15. System as claimed in claim 8, characterized in that the selection means (1) is a merchandise management system, in which, based on a change of price, a change of product description or a change of the item/pattern assignment, data are transmitted to the data processing means (2) and here new output information for the corresponding output device (3) is automatically generated.
